(19) United States
(12) Patent Application Publication
(10) Pub. No.: US 2008/0210892 A1
(43) Pub. Date: Sep. 4, 2008

(54) Radiation-Shielding Container Having Status-Indicative Labeling System

(76) Inventor: Gary S. Wagner, Independence, KY (US)

Correspondence Address: Mallinckrodt Inc., 675 McDonnell Boulevard, HAZELWOOD, MO, 63042, US

(21) Appl. No.: 11/914,148

(22) PCT Filed: May 12, 2006
(86) PCT No.: PCT/US06/18884

§ 371 Date: Nov. 12, 2007

Related U.S. Application Data
(60) Provisional application No. 60/681,562, filed on May 16, 2005.

(51) Int. Cl. G21F 5/06

(52) U.S. Cl. 250/515.1

(57) ABSTRACT

One or more aspects of the invention is directed to a radiation-shielding container for housing a radiopharmaceutical. A labeling system is attached to an exterior surface of the container. The labeling system is adapted to selectively convert from a first state to a second state. In the first state, the labeling system indicates a first condition of the radiopharmaceutical. For example, in the first state, the labeling system can show that the radiopharmaceutical is ready for administering. In the second state, the labeling system indicates a second condition of the radiopharmaceutical. For example, in the second state, the labeling system can show that the radiopharmaceutical has been administered, and/or that a syringe that was used to administer the radiopharmaceutical is now a biohazard.

### FIELD OF THE INVENTION

This invention relates to handling of radiopharmaceuticals in containers, and more particularly to systems, devices, and methods for easier and more reliable use of information relating to a radiopharmaceutical in a radiation-shielding container.

### BACKGROUND

Radiopharmaceuticals (i.e., pharmaceuticals that are radioactive) are dispensed by radiopharmacies in radiation-shielding containers for temporary storage before they are used. The radiation-shielding containers have labels including important information regarding the type of radiopharmaceutical and directions for administration thereof. In hospitals and clinics, these labels are important, for example, in promoting proper administration of the correct radiopharmaceutical at the right time to the proper patient. Radiopharmaceuticals are typically prepared at a radiopharmacy that specializes in preparation of radiopharmaceuticals and then transported to a remote health care facility where they are administered to patients. The fact that the radiopharmaceuticals are radioactive triggers the need to comply with safety regulations promulgated by the Department of Transportation (DOT), the Nuclear Regulatory Commission (NRC), and the Occupational Health and Safety Administration (OSHA). The regulations require use of a radiation-shielding container during transport of a radiopharmaceutical to protect people from unnecessary exposure to the radiation emitted by the radiopharmaceutical. Suitable radiation-shielding containers are commonly known in the industry as radiopharmaceutical pigs.

Radiopharmaceuticals have limited shelf lives because of their radioactive decay and the need for relatively precise activity at the time of their administration. Thus, radiopharmaceuticals are typically delivered to healthcare facilities in unit-doses, each of which is enclosed in its own radiopharmaceutical pig. Radiopharmaceutical pigs are commonly sized to contain only a single dose. Liquid radiopharmaceuticals are typically administered by syringe (e.g., via subcutaneous injection through a hypodermic needle). Thus, a common type of radiopharmaceutical pig is a radiation-shielding container sized to contain a single unit-dose syringe containing a liquid radiopharmaceutical.

Generally, this type of radiopharmaceutical pig is a two-part elongate cylindrical container that can be assembled (e.g., by fastening one part of the container onto another) to form a cavity sized and shaped to hold a single syringe. The size and shape of the cavity of this type of pig may vary from one pig to another to accommodate different types of syringes having different dimensions. The radiopharmaceutical pig includes a radiation-shielding material, such as a layer of lead or tungsten, operable to substantially shield the exterior of the pig from radiation emitted inside the cavity of the assembled pig. More detailed information about the construction of radiopharmaceutical pigs is provided in commonly owned PCT application PCT/US2003/030227, filed Sep. 24, 2003, the contents of which are hereby incorporated by reference.

Some radiopharmaceuticals (e.g., radioactive Iodine) are typically dispensed in capsules or vials. These capsules or vials can be transported in radiation-shielding containers, for example as described in U.S. Pat. No. 5,834,788, which are also sometimes referred to as radiopharmaceutical pigs. The radiopharmaceutical pigs of the type described in the '788 patent have an internal cavity when assembled that is sized and shaped to contain a vial or capsules rather than a syringe. The majority of radiopharmaceuticals, however, are in liquid form and dispensed in syringes.

After a syringe containing a dose of a radiopharmaceutical is transported to a health care facility in a radiopharmaceutical pig, the pig can be opened and the syringe taken out to administer the radiopharmaceutical to a patient, thereby producing a spent syringe. The syringe commonly has a hypodermic needle used for subcutaneous injection of the radiopharmaceutical, in which case the radiopharmaceutical pig may serve double duty as a radiation-shielding container and a protective sharps container (i.e., a container designed to reduce the risk of needle stick injuries from a potentially contaminated needle) during transport of the spent syringe to a disposal facility equipped to handle waste that is both radioactive and biologically contaminated. Radiation shielding of the spent syringe is required because the syringe may still contain residue of the radiopharmaceutical. Further, disposal of a spent syringe having a potentially contaminated hypodermic needle triggers OSHA's blood borne pathogen regulations, codified at 29 C.F.R. § 1910.1030, et. seq., which require the use of a sharps container to reduce the risk of exposure of people to pathogens by needle stick injuries.

Applicable government regulations and industry standards require labels to be attached to the radiopharmaceutical pigs to indicate certain information about their contents. One label is attached to each of the syringes, but this label is not visible when the syringe is enclosed in a pig. Another label is typically attached to the side of each radiopharmaceutical pig by a radiopharmacy before shipment to a facility that will use the radiopharmaceutical. For example, FIG. 1 shows a radiopharmaceutical pig 11 having a syringe (not shown) having a label 13 attached to its side. The label 13 has been attached to the side of the pig 11 by a suitable fastener such as a transparent retaining sleeve, an adhesive, or a rubber band.

Medical technicians who administer radiopharmaceuticals to patients use the information on the labels attached to the pigs to match the radiopharmaceuticals to the corresponding patients and verify proper use of the radiopharmaceuticals. The format and exact contents of the labels may vary from one radiopharmacy to the next, but the labels generally contain a substantial amount of information, some of which is required for compliance with applicable safety regulations and standards and some of which may optionally be included for business purposes (e.g., inclusion of an invoice number).

Although the conventional labels described above contain the necessary and desired information for a particular radiopharmaceutical dose, the labels are not user friendly. For instance, text on the labels, which are commonly on the order of 2.5 inches by 3.5 inches in size, is printed in a relatively smaller font to make room for all of the information on the label. The label is also visually congested because of the amount of information, inhibiting reference to the label for the most pertinent information and adding to the risk of possible confusion of medical technicians handing the radiopharmaceutical. Further, multiple radiopharmaceutical pigs are commonly stored upright in a secondary storage box (see FIG. 6), such as a storage case facilitating shipment of the multiple pigs to a single healthcare facility. When stored upright, it is difficult or impossible to view the labels on the sides of the pigs without lifting the pigs out of the container. Likewise, a plurality of pigs may be placed in a storage rack (not shown) at a healthcare facility in a manner that obstructs viewing of the labels on the sides of the pigs. Thus, medical technicians have to lift a pig at least partially out of the storage box (or rack) to read its label. This can frustrate efforts to distinguish and retrieve a particular radiopharmaceutical pig and may increase the risk of mix ups caused by accidental retrieval of the wrong pig.

Healthcare facilities commonly place the used pigs back in the storage box or rack after the dose of the radiopharmaceutical has been used for subsequent return of the pigs to the radiopharmacy. Thus, another point of possible confusion is that it may not be readily apparent from looking at the pigs in a rack or case which contain unused radiopharmaceuticals and which do not. This may induce medical technicians to open the pigs to find out whether or not the pigs contain unused radiopharmaceuticals, which would result in unnecessary radiation exposure and possibly exposure to hazardous medical waste. Some healthcare facilities have adopted a practice of replacing pigs back in their storage case or rack upside down after the radiopharmaceutical has been administered to a patient, the upside down orientation signaling that the pig's contents have been used. Unfortunately, this increases the risk that a person removing the upside down pig from the rack or case will accidentally open the pig, if for example twisting during removal of the pig unscrews its top. Opening of the pig in this manner is undesirable because its contents may spill out exposing the worker to radiation and a potentially contaminated needle of a spent radiopharmaceutical syringe.

Another method that some healthcare facilities use to keep track of which pigs contain unused radiopharmaceuticals and which do not is to segregate the pigs (e.g., by keeping them in separate drawers) containing unused radiopharmaceuticals from those that do not. The pigs are sometimes also segregated on the basis of the time of day that the radiopharmaceutical they contain is to be used, the procedure involved, etc. This wastes space unnecessarily by requiring medical technicians to establish segregated spaces in which to place the pigs. Further, pigs can be easily misplaced as a result of incorrect reading of the label, thereby resulting in delay and confusion.

Thus, there is a need for systems, devices and methods promoting easier and more reliable use of information relating to unit-doses of radiopharmaceuticals.

### SUMMARY

In one aspect of the invention, a radiopharmaceutical pig for a radiopharmaceutical comprises a body defining a cavity for receiving the radiopharmaceutical. A labeling system is attached to an exterior surface of the body. The labeling system is adapted to selectively convert from a first state to a second state. In the first state the labeling system indicates a first condition of the radiopharmaceutical. In the second state the labeling system indicates a second condition of the radiopharmaceutical.

In another aspect of the invention, a radiopharmaceutical container for containing a radiopharmaceutical comprises a generally elongate (and sometimes cylindrical) body defining an internal cavity for receiving the radiopharmaceutical. The body has a side wall and first and second end walls. The first end wall is normally visible and the side wall is normally obscured in a storage position of the container. The radiopharmaceutical container includes a main label and a reference label. The main label is attached to the side wall of the body and includes a marking of information relating to the radiopharmaceutical. The reference label is attached to the first end wall of the body and includes a marking of information which may be a subset of the information marked on the main label.

Yet another aspect of the invention relates to a method of handling a radiopharmaceutical in which a pharmaceutical container (such as a syringe) containing the radiopharmaceutical is placed into a radiopharmaceutical pig. A labeling system secured to the radiopharmaceutical pig is in a first state in which the labeling system indicates that the radiopharmaceutical is ready for administration to a patient. The pharmaceutical container is removed from the radiopharmaceutical pig and administered to a patient. The pharmaceutical container is replaced in the radiopharmaceutical pig and the labeling system is converted from the first state to a second state in which the labeling system indicates that the radiopharmaceutical has been administered.

Still another aspect of the invention relates to a radiopharmaceutical container system that includes a radiation-shielding container and a syringe disposed within a cavity of the radiation-shielding container. In addition, this container system includes a label system associated with (e.g., fastened to, adhered to, integral with, deposited on, and the like) an exterior of the radiation-shielding container. When the label system is in a first state, it includes marking indicative of a first condition of the syringe. By contrast, when the label system is in a second state, it includes marking indicative of a second condition of the syringe that is different from the first condition.

Yet still another aspect of the invention relates to a method of using a radiopharmaceutical container system. In this method, a syringe containing a radiopharmaceutical is disposed in a radiation-shielding container. A first label is applied to the radiation-shielding container to indicate a first condition of the syringe and/or the radiopharmaceutical disposed therein. The first label may be dissociated from the radiation-shielding container to expose marking indicative of a second condition of the syringe and/or the radiopharmaceutical. The marking that may be exposed is associated with (e.g., fastened to, adhered to, integral with, deposited on, and the like) the radiation-shielding container.

Various refinements exist of the features noted in relation to the above-mentioned aspects of the present invention. Further features may also be incorporated in the above-mentioned aspects of the present invention as well. These refinements and additional features may exist individually or in any combination. For instance, various features discussed below in relation to any of the illustrated embodiments of the present invention may be incorporated into any of the aspects of the present invention.

### BRIEF DESCRIPTION OF THE FIGURES

FIG. 1 is a perspective of a prior art radiopharmaceutical pig;

FIG. 2 is a perspective of one embodiment of a radiopharmaceutical pig of the present invention;

FIG. 3 is a cross section of the radiopharmaceutical pig shown in FIG. 2;

FIGS. 4 & 5 are top plan views of the radiopharmaceutical pig shown FIG. 2 showing a sequence in which a reference label is removed from the pig;

FIG. 6 is a storage box containing a plurality of radiopharmaceutical pigs like the pig shown in FIG. 2;

FIG. 7 is a perspective of the reference label removed in the sequence of FIGS. 3 & 4 being attached to a log; and

FIG. 8 is a perspective of the radiopharmaceutical pig shown in FIG. 2 after the pig has been readied for reuse.

Corresponding reference characters indicate corresponding parts throughout the figures.

### DETAILED DESCRIPTION OF THE ILLUSTRATED EMBODIMENTS

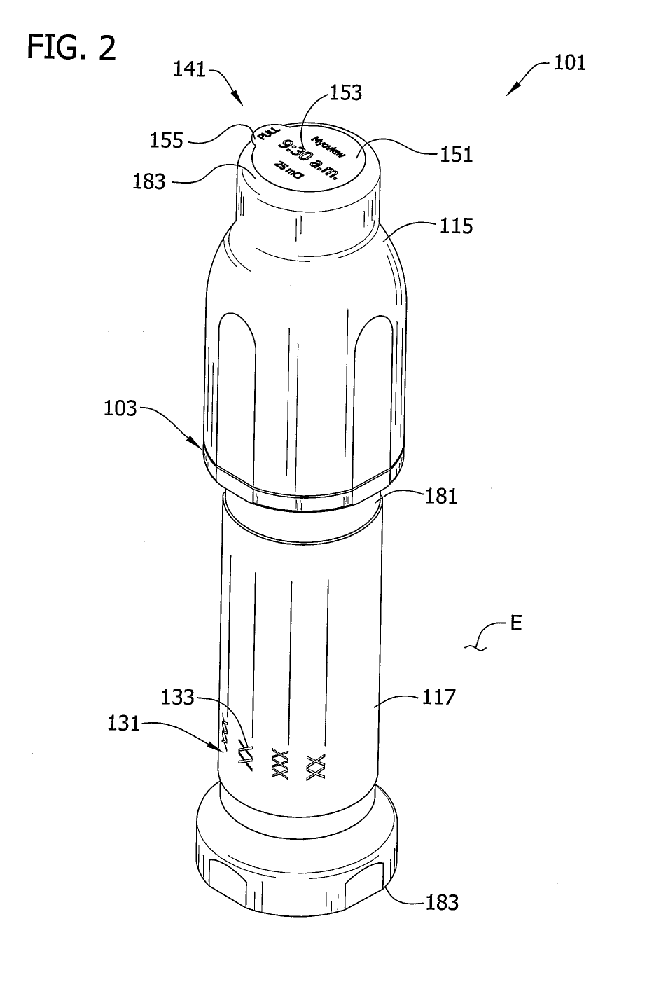

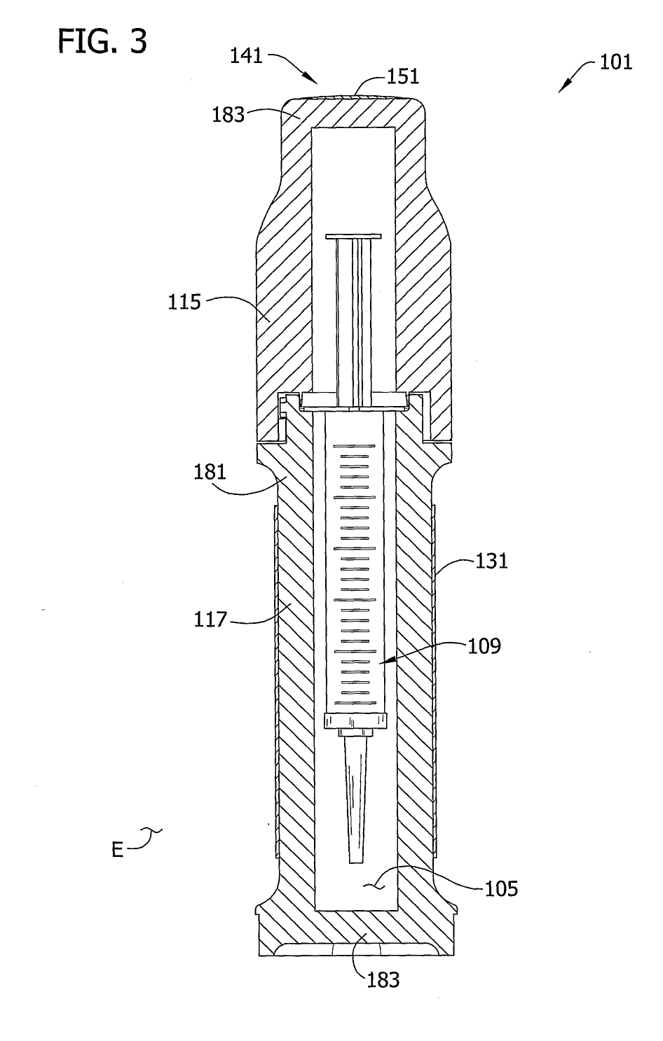

Referring now to the figures, first to FIG. 2 in particular, a radiopharmaceutical pig, generally designated 101, comprises a body 103 for enclosing a single dose of a radiopharmaceutical. The radiopharmaceutical pig 101 holds a single syringe 109 (shown FIG. 3) containing a unit-dose of a liquid radiopharmaceutical. The pig 101 comprises a top portion 115 and a bottom portion 117 that are releasably securable to one another to form the body 103. As is well-known to those skilled in the art, when the top and bottom portions 115, 117 are attached to one another (as shown in FIG. 2) they define a cavity 105 (i.e., receptacle) for housing the single syringe 109 and substantially shield an exterior environment E from radiation emitted in the cavity 105 by the radiopharmaceutical. The body portions 115, 117 can be released from one another for loading or unloading of the syringe 109 to or from the cavity 105. Although the radiopharmaceutical pig shown in the figures is a radiopharmaceutical pig 101 adapted to receive a single syringe, a different radiopharmaceutical pig, such as one that is adapted to contain a vial or capsule containing a radiopharmaceutical could also be used without departing from the scope of the invention. Further, a different radiopharmaceutical pig, such as one that is adapted to accommodate a plurality of syringes, vials and/or capsules could also be used without departing from the scope of the invention. The body 103 and/or body portions 115, 117 may be formed entirely from a radiation shielding material or as a combination including radiation shielding materials and other materials that do not block a significant amount of radiation. To say the body 103 and/or body portions 115, 117 include radiation shielding material is intended to encompass bodies made entirely or partially of radiation shielding material.

A main label 131 is attached to the body 103 of the radiopharmaceutical pig 101 and comprises a marking 133 (e.g., wording, abbreviations, codes, symbols, etc.) conveying any appropriate information, for example, relating to the radiopharmaceutical and/or the administration thereof. The main label 131 can be attached to the body 103 of the pig 101 in any appropriate manner such as by any suitable fastener(s), such as a retaining sleeve, adhesive, rubber band, etc. In some embodiments, the main label 131 is larger than about 5 square inches in size; in some embodiments, the main label 131 is larger than about 8 square inches in size; and in some embodiments, the main label is generally rectangular in shape and about 2.5 inches by about 3.5 inches in size when in a flattened condition. Various embodiments of the invention include main labels 131 of numerous shapes and sizes.

The marking 133 on the main label 131 can convey, for example and without any limitation, any of the following pieces of information or any combination thereof:
i. a description of the radiopharmaceutical (e.g., “Tc-99m Technescan MAG-3 ™”);
ii. the procedure to be conducted with the radiopharmaceutical (e.g., “renal image and function study”);
iii. the activity of the radiopharmaceutical (e.g., “5 mCi at 10:30 AM on 24 May 2005”) sometimes referred to in the art as the “calibration time” of the radiopharmaceutical;
iv. the volume of the radiopharmaceutical;
v. the concentration of the radiopharmaceutical;
vi. the prescribed administration time;
vii. the expiration time;
viii. the dispensing date;
ix. the name and address of the destination hospital or medical facility;
x. the name and address of the radiopharmacy that has filled the prescription;
xi. the prescription number;
xii. a radioactive material warning symbol;
xiii. statements regarding NRC approval of distribution of the radiopharmaceutical to licensed entities;
xiv. information (e.g., name) regarding the patient to whom the radiopharmaceutical is to be administered;
xv. the name of the physician;
xvi. the manufacturer of the radiopharmaceutical;
xvii. an invoice number;
xviii. delivery date and/or time;
xix. a container number (e.g., container 1 of 5);
xx. identity of radiopharmacist who filled the prescription;
xxi. lot number;
xxii. notes and/or cautions (e.g., contraindications).

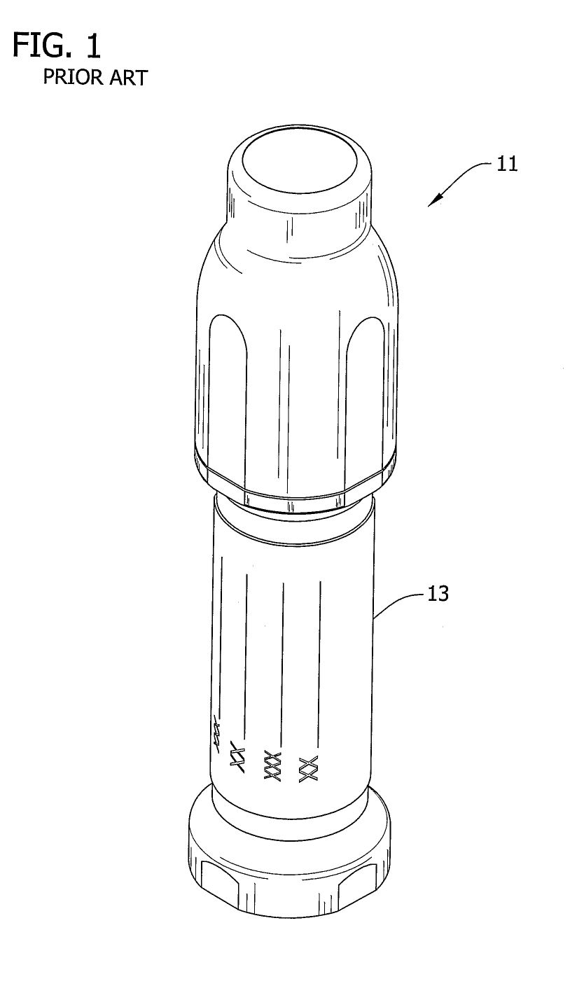

Although other labels can be used without departing from the scope of the invention, the main label 131 shown in the figures is the same type of label shown in the prior art radiopharmaceutical pig of FIG. 1 and discussed in the background section above. Thus, it will be recognized that the marking 133 of the main label 131 includes relatively detailed information about the radiopharmaceutical. Moreover, the main label can be omitted from some embodiments without departing from the scope of the invention.

A status-indicating labeling system, generally designated 141, is attached to the radiopharmaceutical pig 101. The status-indicating labeling system 141 is adapted to selectively convert from a first state indicating a first condition of the radiopharmaceutical and/or the syringe 109 to a second state indicating a second condition of the radiopharmaceutical and/or the syringe 109. For instance, the first condition indicated by the labeling system 141 may be a state of readiness of the radiopharmaceutical and/or syringe 109 for use while the second condition indicated by the labeling system is a state of prior administration of the radiopharmaceutical and/or syringe 109. For example, in the second state, the labeling system 141 may show that the radiopharmaceutical has been administered or otherwise spent and is indicative of the syringe 109 being biologically contaminated. The status-indicating labeling system 141 may also be adapted to be returned to its first state with little or no additional time or expense.

Referring to the version of the labeling system 141 shown in the figures, for example, a reference label 151 includes a marking 153 (e.g., wording, abbreviations, codes, symbols, etc.) that may convey relatively less detailed information about the radiopharmaceutical than the marking 133 on the main label 131. This reference label 151 is removably attached to the body 103 of the radiopharmaceutical pig 101. The reference label 151 can be attached to the body 103 in any appropriate manner, such as by a relatively low-tack peelable adhesive. The reference label 151 may include an outwardly projecting pull tab 155 that may be said, in at least some regard, to facilitate manual grasping of the reference label 151 (e.g., as peeling of the label is being initiated). The adhesive may be the same adhesive as is used to apply the main label 131. However, any suitable arrangement for removably attaching a label to the pig can be used without departing from the scope of the invention.

The reference label 151 may be smaller in area of coverage than the main label 131. For instance, the reference label 151 of some embodiments may cover no more than about 2.5 square inches; in some embodiments, the reference label 151 may cover no more than about 2 square inches; and the reference label 151 of some embodiments may cover between about 1.5 and about 2 square inches. Various other embodiments of the reference label 151 may exhibit other appropriate sizes and dimensions. The reference label 151 shown in the figures is generally circular, but it could have virtually any shape without departing from the scope of the invention. For reasons that will be explained later herein, in the case that the radiopharmaceutical pig 101 has both a main label 131 and a reference label 151 associated therewith, the reference label 151 of some embodiments may be attached to a different part of the pig 101 than the main label 131. In the embodiment shown in the figures, for example, the body 103 of the pig 101 is at least generally cylindrical and has an at least generally circumferential side wall 181 that extends between two opposing end walls 183. As shown in FIG. 2, the main label 131 is attached to the side wall 181, and the reference label 151 is attached to one of the end walls 183. However, the reference label 151 can be attached to the same part of the body 103 as the main label 131 without departing from the scope of the invention.

In the illustrated embodiment, the relatively less detailed marking 153 of the reference label 151 generally conveys a subset of the information on the main label 131, such as the name of the radiopharmaceutical, the name of the patient, the prescribed administration time of the radiopharmaceutical, the activity of the radiopharmaceutical, the name of a doctor who prescribed the radiopharmaceutical, the name of a procedure to be performed using the radiopharmaceutical, etc. The exact information included on the reference label 151 may vary depending on factors such as, but not limited to, the type of radiopharmaceutical and the procedures of the particular radiopharmacy and healthcare facility involved. With regard to this particular embodiment, the information is suitably selected for display on the reference label 151 because it is expected to facilitate efficient and reliable handling of the radiopharmaceutical by medical technicians. That information may be cumulative of information included in the marking 133 of the main label 131. However, the markings 133, 153 may include different (e.g., overlapping or completely different) information without departing from the scope of the invention.

The marking 153 of the reference label 151 suitably comprises what may be characterized in at least one regard as a more readable representation of information than the marking 133 of the main label 131. For example, the marking 153 of the reference label 151 of the embodiment shown in the figures comprises text written in a larger, bolder face, and/or higher contrast font to facilitate reading of the reference label 151. Because it includes less information, the marking 153 of the reference label 151 is also less congested than the marking 133 of the main label 131. However, some advantages of the invention do not depend on better readability of the reference label 151. Thus, a reference label that is no more readable, or even less readable, than the main label can be used without departing from the scope of the invention.

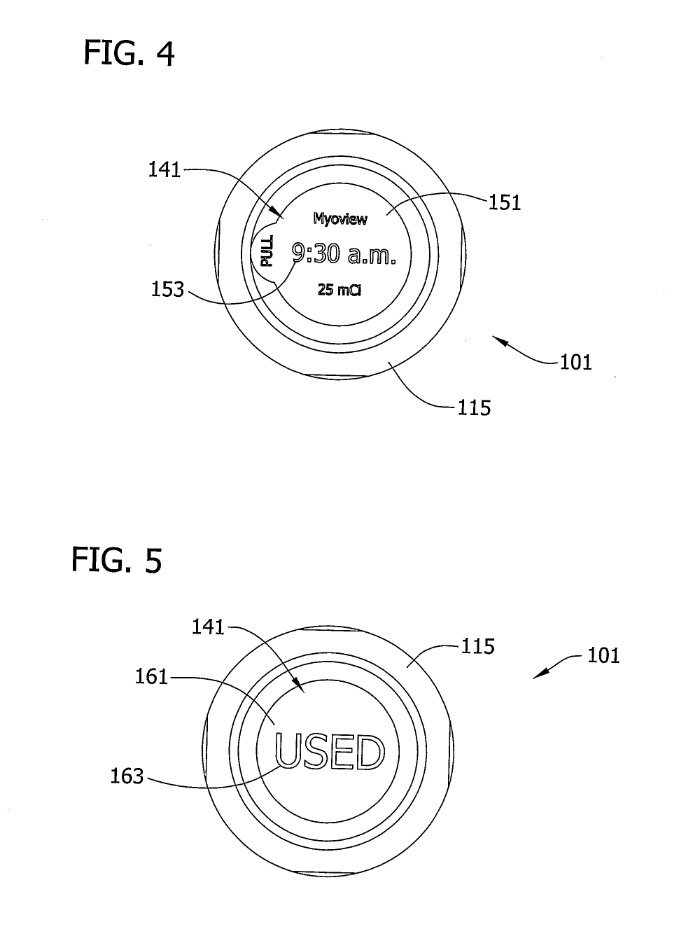

The reference label 151 forms a first label of the version of the labeling system shown in the figures. The reference label 151 overlies (e.g., covers) a portion 161 (which will be referred to as a “second label”) of the radiopharmaceutical pig 101 when it is attached thereto. Referring to FIGS. 4 and 5, for example, when the reference label 151 is attached to the body 103 (FIG. 4) it obstructs viewing of at least a portion (and preferably a substantial entirety) of the second label 161. The second label 161 is visible when the reference label 151 is removed from the body (FIG. 5). The second label 161 has an appearance that is different from the appearance of the reference label 151 so the outward appearance of the pig 101 is changed upon removal of the reference label. For example, the second label 161 may include a marking 163 conveying information that is different from the marking 153 of the reference label 151 as shown in FIGS. 4 and 5. The marking 163 of the second label 161 can be formed integrally with the body 103 of the pig 101 such as by molding, printing, forming and/or etching the body. As illustrated, the second label 161 is formed by printing directly on the body 103 of the pig 101. However, a suitable marking can be attached to the body 103 (e.g., printed on a sticker that is attached to the pig or painted (or otherwise deposited) onto the pig) rather than an integral part of the body without departing from the scope of the invention. The marking 163 of the second label 161 is preferably about the same size or smaller than the reference label 151, although the marking 163 of the second label can be larger than the reference label 151 without departing from the scope of the invention.

In one version of the invention shown in FIG. 5, the marking 163 of the second label 161 indicates (e.g., by wording, symbols, codes, etc.) that the radiopharmaceutical has already been used (e.g., administered from a syringe into a patient). In other versions, the second label includes one or more visual cues, such as a marking conveying different information than the marking on the reference label 151 or a marking including the same information along with other visual cues (e.g., color, size, and/or style differences) distinguishing the appearance of the second label from the reference label. The marking 163 on the second label 161 may signal the presence of any hazard or other pertinent information, such as by appropriate wording, symbols, and/or color coding used in the industry. In other versions of the radiopharmaceutical pig 101, the marking 163 on the second label 161 simply indicates that the pig is empty. Any marking 163 covered by the reference label 151 can be revealed by removal of the reference label, as discussed in more detail later herein. In another version, however, the portion of the pig that is covered by the reference label 151 is free from marking (or what may be characterized as “positive marking”), but the perception by a medical technician of the absence of the reference label 151 signals that the radiopharmaceutical in the pig has already been administered. In this particular event, the unmarked portion constitutes a “second label” or “negative marking”.

The reference label 151 can be attached directly to the body 103 of the radiopharmaceutical pig 101 as shown in the figures. However, the reference label 151 could instead be indirectly attached to the body 103. For example, a second label (not shown) can comprise a marking printed on a sheet of paper (e.g., sticker) attached to the body 103 of the pig 101 (e.g., using an adhesive), and the reference label 151 can be indirectly attached to the body of the pig by being attached to the second label (e.g., using an adhesive). In this version of the pig, it is desirable for the second label to be attached to the body 103 of the pig in a manner that is more resistant to removal than the reference label 151. For instance, a relatively more aggressive adhesive may be used to adhere the second label to the body 103 and a relatively less aggressive adhesive used to adhere the reference label 151 to the second label.

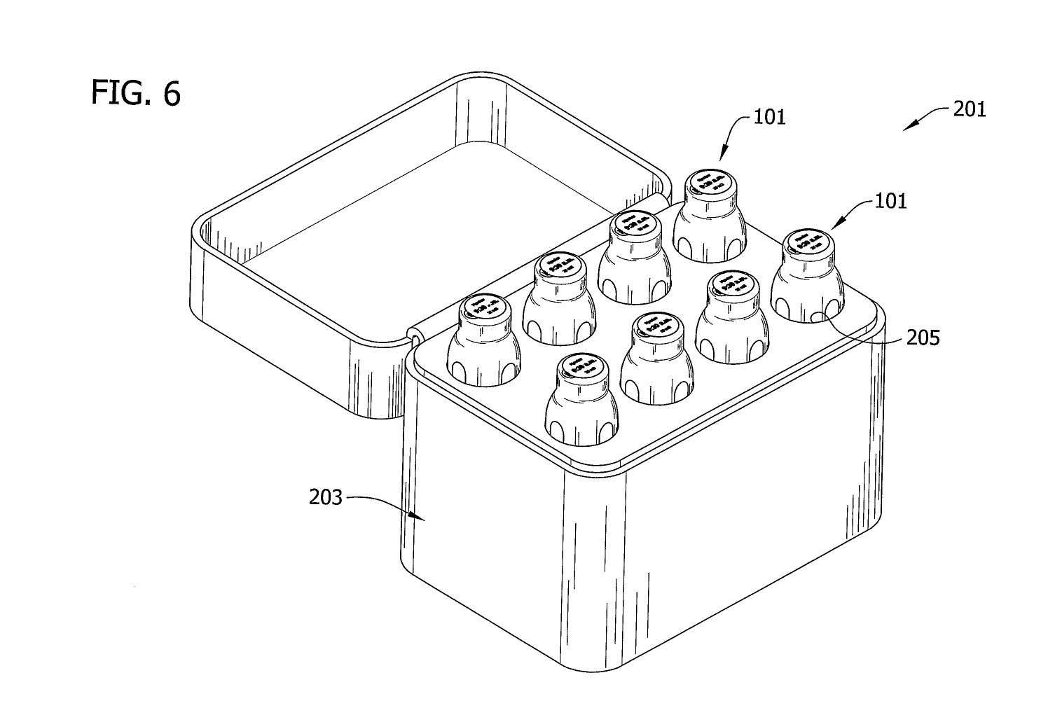

The advantage of having the main label 131 attached to a different part of the pig 101 than the reference label 151 is apparent upon consideration of the system for handling radiopharmaceuticals shown in FIG. 6, and generally designated 201, which comprises a plurality of radiopharmaceutical pigs 101 received in a storage box 203. The storage box 203 shown in the figures is a portable storage case, but it will understood that other types of storage containers (e.g., a wall-mounted storage rack) could be used without departing from the scope of the invention. The storage box 203 comprises a plurality of receptacles 205 (e.g., an array of receptacles), each of which is sized to receive a single one of the pigs 101. The pigs 101 are placed in the cavities 205 lengthwise, bottom portion 117 first as is customary in the industry. In this position, which is the normal position in which pigs are stored, the view of side wall 181, and consequently the view of the main label 131, is obscured. On the other hand, the end walls 183 on the top portions 115 of the pigs 101 are not obscured even though the pigs are received in the receptacles 205. Further, the reference labels 151 on the end walls 183 of the top portions 115 of the pigs 101 are visible without lifting the pigs out of the receptacles 205. Thus, a particular pig 101 can be identified just by looking at the end walls 183 of the top portions 115 of the pigs without inspecting the main labels 131, thereby potentially obviating the need to lift the outer containers 101 out of the storage box 203 to find a particular pig.

In some embodiments of the invention, the conversion of the labeling system 141 from its first state to its second state may be reversible. For example, when the pig 101 is returned to the radiopharmacy for reuse with another radiopharmaceutical, another reference label 151 having an appropriate marking 153 corresponding to the new radiopharmaceutical dose can be secured to the pig in the same manner as the previous reference label to restore the labeling system 141 to its first state. This may occur, for example, after the pig 101 has been cleaned and a new syringe placed in it. In embodiments in which the reference label 151 is attached to a second label, the second label may be reused multiple times or replaced after each usage of the pig 101. Further, upon return of the pig 101 to the radiopharmacy there is no need to repair or replace any damaged structure associated with normal use of the labeling system 141 to convert the labeling system back to its first state. These features facilitate reuse of the status indicating labeling system 141.

In a method of the present invention, a radiopharmaceutical is dispensed by radiopharmacy by being loaded into a syringe 109. The syringe 109 is enclosed in the cavity 105 of a radiopharmaceutical pig 101 for shipment to a healthcare facility (see FIG. 3). Referring to FIG. 2, a main label 131 may be prepared with the appropriate marking 133 and attached to the side wall 181. A reference label 151 with an appropriate marking 123 is prepared and attached to the pig, preferably to one of the end walls 183, and more preferably to the end wall of the top portion 115 of the pig 101. The pig 101 is then placed lengthwise in a receptacle 205 of a storage box 203 (FIG. 6) along with at least one, and in most cases, multiple additional pigs 101 prepared and placed in receptacles 205 of the storage box 203 in essentially the same way. Of course, the radiopharmaceuticals and/or labeling will be different among the various pigs. In one version of the method, the storage box 203 is closed and the pigs 101 are transported to a healthcare facility in the storage box. In another version, however, the pigs 101 are removed from the box 203 at the healthcare facility and stored temporarily a storage rack.

However the pigs 101 are stored at the healthcare facility (e.g., in a storage box 203, a storage rack, or other storage arrangement), a medical technician at the healthcare facility identifies and retrieves a particular one of the pigs from storage by looking at their reference labels 151 and the markings 153 thereon. The markings 153 on the reference labels 151 may include any appropriate information herein described with regard to any labels. For example, and without limitation, the medical technician can read any of the following from the reference labels 151 to identify the desired pig: the name of the patient to be given the radiopharmaceutical, the name of the radiopharmaceutical, the time at which the radiopharmaceutical is to be administered, the activity of the radiopharmaceutical, the name of the prescribing doctor, the name of the procedure to be performed using the radiopharmaceutical, and combinations thereof. Preferably, the technician does not lift or otherwise handle the pigs 101 until he identifies the pig containing the desired radiopharmaceutical to be administered.

When the technician finds the pig 101 containing the desired radiopharmaceutical, he removes the pig from storage and disconnects and separates the upper portion 115 from the lower portion 117 to remove the syringe 109 therefrom. The syringe 109 is used to inject (e.g., inject subcutaneously through a hypodermic needle attached to the syringe) the radiopharmaceutical into the patient. At that time, the technician also peels the reference label 151 off the pig 101, thereby revealing the second label 161 and any marking 163 thereon. The technician could wait until after the spent syringe is replaced in the pig 101 to remove the reference label 151. By removing the reference label 151, the technician converts the labeling system 141 from a state in which it indicates a condition of readiness of the radiopharmaceutical in the pig for use to a state in which it indicates a condition of prior administration of the radiopharmaceutical that was contained in the pig.

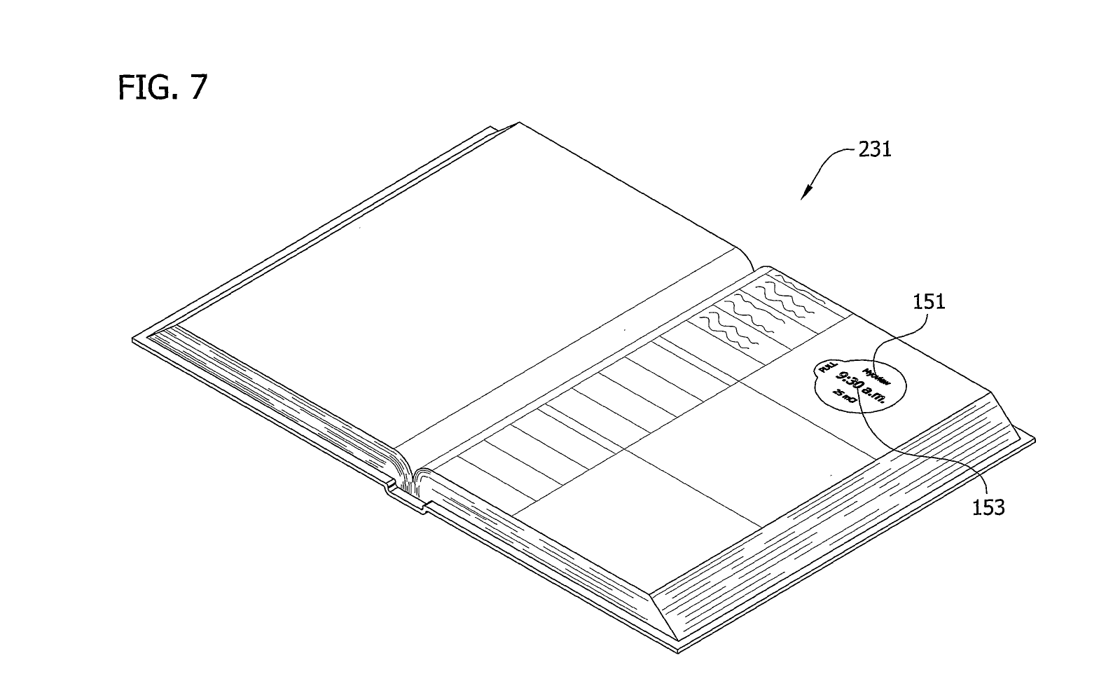

Once dissociated from the radiopharmaceutical pig 101, the reference label 151 may be discarded, saved for reuse, or (as shown in FIG. 7) transferred to a log 231 (e.g., an injection log used to record administration of radiopharmaceuticals by the healthcare facility). For example, after the reference label 151 is dissociated from (e.g., peeled off the body 103 of the pig 101, a reusable adhesive on the back of the reference label 151 can be used to attach the reference label 151 to the log 231. The log 231 can be referred to in order to verify proper administration of radiopharmaceuticals throughout the day. The log 231 may also provide a permanent record of the injection activities of the healthcare facility. Use of the reference label 151 as part of a log entry, reduces the risk that information (including but not limited to the information included on the reference label) will be incorrectly entered into the log 231.

After the reference label 151 has been removed from the pig 101 and the radiopharmaceutical administered to the patient, the (now spent) syringe 109 may be re-enclosed in the cavity 105 of the pig, which is then preferably returned to the storage box in the substantially same orientation that it was in before it was removed. As the technician prepares to use another radiopharmaceutical, the technician simply inspects the top portions 115 of the pigs 101, in particular by looking at the remaining reference labels 151 thereon to identify and retrieve pig that contains the next desired radiopharmaceutical. The process may be repeated, as desired, until all the radiopharmaceuticals in the storage case have been used (or the respective procedures aborted).

At any time, a technician can determine which of the radiopharmaceutical pigs 101 in the storage box 203 contain unused radiopharmaceuticals and which do not by simply looking at the end walls 183 of the top portions 115 of the pigs. Prior removal of a reference label 151 (e.g., by a technician) from one of the pigs 101 reveals a “USED” marking 163 of a second label 161. Technicians will thereafter be made aware of any information conveyed the marking (e.g., that a syringe has been used). Thus, there is little, if any, reason for them to open any of the pigs 101 to determine what is contained therein. After the radiopharmaceuticals have been used (or the need to administer them otherwise resolved), the radiopharmaceutical pigs 101 containing the spent syringes (and in some cases unused radiopharmaceuticals from aborted procedures) are returned to the radiopharmacy (e.g., while they are still in the storage box 203) for disposal of any waste materials therein and preparation of the pigs for reuse in transporting another radiopharmaceutical to a healthcare facility.

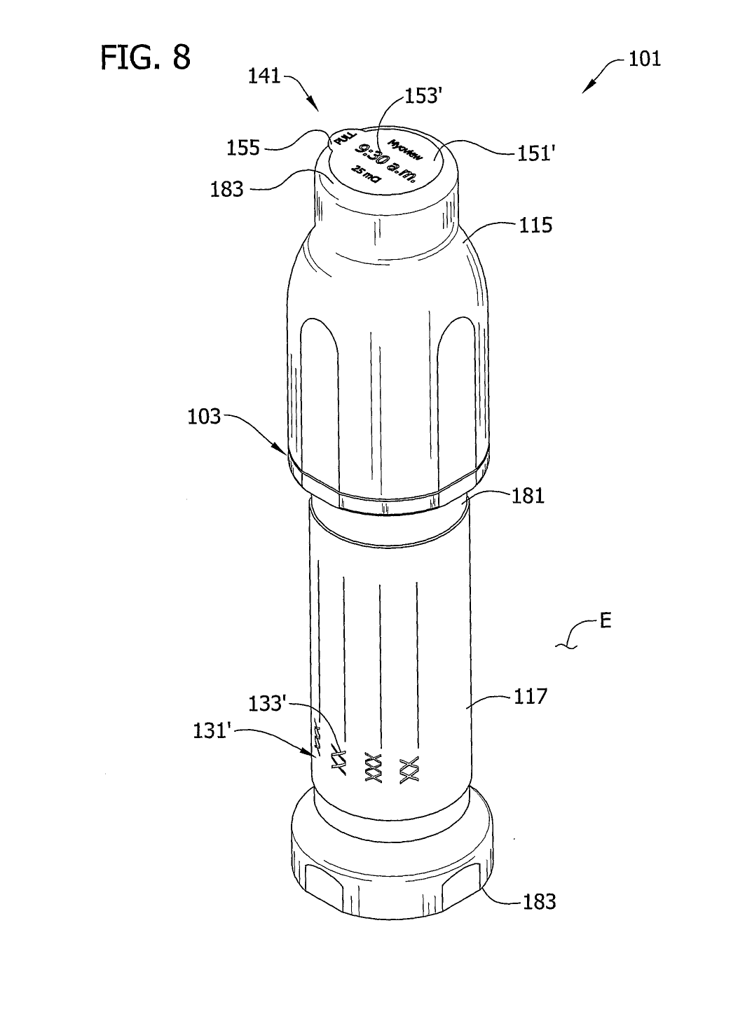

Any of the pigs 101 may be reused, either together or separately, as desired. For example, another radiopharmaceutical (either the same type or a different type) may be loaded into a new syringe (not shown but potentially identical to syringe 109). The new syringe may be enclosed in the cavity 105 of one of the radiopharmaceutical pigs 101 for shipment to a healthcare facility as described above. Referring to FIG. 8, a new main label 131′ may be prepared with the appropriate marking 133′ and attached to the side wall 181 of the pig 101. The status indicating labeling system 141 of the pig 101 may be restored to its first state, for example by preparing and attaching to the pig a new reference label 151′ with an appropriate marking 153′ corresponding to the radiopharmaceutical contained in the new syringe in the pig (e.g., in the same manner as the previous reference label). In some embodiments of the invention, replacement of the previous reference label 151 (which has already been removed upon return of the pig 101 to the radiopharmacy) with the new reference label is all that is required to restore the status indicative labeling system 141 to its first state (e.g., a state indicating that the pig contains a syringe that is ready for use). Notably, the time and effort required to prepare the labeling system 141 for reuse may be no more than the time and effort required to prepare the labeling system for its initial use. The radiopharmaceutical pig 101 may then be reused in the same manner described above.

Although the method described above involves handling of liquid radiopharmaceuticals in unit-dose syringes, those skilled in the art will understand that the systems and methods described herein can be used with other radiopharmaceuticals, including vials of liquid or solid radiopharmaceuticals without departing from the scope of the invention. Further, it will be understood that the plurality of radiation-shielding containers that placed in a storage box may comprise different type of containers, including radiopharmaceutical pigs with different versions of the labeling system 141. Any radiation-shielding container that provides suitable shielding for the particular radiopharmaceutical can be used instead of the pig 101 shown and described above. Moreover, it will be understood by those skilled in the art that use of only one, or a plurality, of the pigs 101 without any secondary storage structure does not depart from the scope of the invention. Still further, it should be appreciated that any of the various labels of the invention may be customized to fit the particular desires of a user. For instance, the markings included on one or more of the various labels of some embodiments of the invention may include, without limitation, any desired informational content, any desired font(s), any desired type-size(s), and any desired font style(s).

When introducing elements of the present invention or the preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above systems and methods without departing from the scope of the invention, it is intended that all matter contained in the above description and shown in the accompanying figures shall be interpreted as illustrative and not in a limiting sense.

1-23. (canceled)

24. A radiopharmaceutical pig comprising:
a body including radiation shielding material and defining a cavity for receiving a radiopharmaceutical, the body further including body portions releasable from each other for loading or unloading the radiopharmaceutical to or from the cavity; and
a labeling system located on an exterior surface of the body, the labeling system being adapted to selectively convert from a first state to a second state independently of releasing the body portions, in the first state the labeling system providing textual information regarding the radiopharmaceutical and/or its use and indicating a first condition of the radiopharmaceutical and in the second state the labeling system indicating a second condition of the radiopharmaceutical.

25. The pig of claim 24, wherein the labeling system comprises a first label and a second label, the first label being attached to the body in the first state and having a marking indicative of the first condition of the radiopharmaceutical, the first label at least partially covering the second label in the first state.

26. The pig of claim 25, wherein the first label is removably attached to the labeling system whereby upon removal of the first label the labeling system converts to the second state and the second label is at least partially uncovered.

27. The pig of claim 26, wherein the first label is adapted to be peeled off of the second label.

28. The pig of claim 27, wherein the first label includes a tab projecting outwardly from the first label for manually grasping the first label to peel it off of the second label.

29. The pig of claim 26, wherein the second label has a marking indicative of the second state of the radiopharmaceutical.

30. The pig of claim 29, wherein the marking on the first label and the marking on the second label each comprises text.

31. The pig of claim 30, wherein the first condition indicated by the marking on the first label is a condition of readiness for administration of the radiopharmaceutical to a patient.

32. The pig of claim 31, wherein the second condition indicated by the marking on the second label is a condition of prior administration of the radiopharmaceutical.

33. The pig of claim 24, wherein the labeling system is adapted to be converted back to the first state after it has been converted to the second state.

34. The pig of claim 24, further comprising a syringe disposed in the cavity.

35. A method of handling a radiopharmaceutical, the method comprising:
placing a container containing the radiopharmaceutical into a radiopharmaceutical pig including radiation shielding material, the radiopharmaceutical pig comprising body portions that are releasable from one another for opening and closing the radiopharmaceutical pig;
securing a labeling system to the radiopharmaceutical pig, the labeling system being in a first state in which the labeling system indicates that the radiopharmaceutical is ready for administration to a patient;
opening the radiopharmaceutical pig and removing the container from the radiopharmaceutical pig;
administering the radiopharmaceutical to a patient;
replacing the container in the radiopharmaceutical pig; and
converting the labeling system from a first state to a second state in which the labeling system indicates that the radiopharmaceutical has been administered, wherein the converting is performed independently of the opening.

36. The method of claim 35, wherein the converting comprises moving a first label of the labeling system to expose at least a portion of a second label of the labeling system.

37. The method of claim 36, wherein the moving comprises removing the first label from the second label.

38. The method of claim 37, wherein the moving comprises grasping a tab of the first label, the tab projecting outwardly from the first and second labels, and pulling the first label off of the radiopharmaceutical pig.

39. The method of claim 37, further comprising securing the removed first label to a log for use in making a record of use of the radiopharmaceutical.

40. The method of claim 35, further comprising converting the labeling system from the second state back to the first state.

41. A radiopharmaceutical container for containing a radiopharmaceutical, the container comprising:
a generally elongate body including radiation shielding material and defining an internal cavity for receiving the radiopharmaceutical, the body having a side wall and first and second end walls at opposite ends of the cavity, the first end wall being normally visible and the side wall being normally obscured in a storage position of the container;
a main label attached to the side wall of the body and including a marking of information relating to the radiopharmaceutical; and
a reference label attached to the first end wall of the body and including a marking of information which is a subset of the information marked on the main label.

42. The container of claim 41, wherein the information on the main label is in text of a first size and the subset of information on the reference label is of a second size larger than the first size.

43. The container of claim 42, wherein the subset of information on the reference label includes at least one of a name of the radiopharmaceutical, a time at which the radiopharmaceutical is to be administered, and an activity level of the radiopharmaceutical.

44. The container of claim 41, wherein the subset of information on the reference label includes at least one of: a procedure to be performed using the radiopharmaceutical, and a name of a doctor who prescribed the radiopharmaceutical.

45. The container of claim 41, wherein the reference label is adapted to selectively convert from a first state to a second state, wherein, in the first state, the reference label indicates a first condition of the radiopharmaceutical, and wherein, in the second state, the reference label indicates a second condition of the radiopharmaceutical.

46. The container of claim 41, further comprising a syringe disposed in the cavity.

47. A storage container comprising:
a plurality of receptacles to accommodate a plurality of radiopharmaceutical containers; and
a radiopharmaceutical container disposed in one of the receptacles, the radiopharmaceutical container comprising:
a generally elongate body including radiation shielding material and defining an internal cavity for receiving the radiopharmaceutical, the body having a side wall and first and second end walls at opposite ends of the cavity;
a main label attached to the side wall of the body and including a marking of information relating to the radiopharmaceutical; and
a reference label attached to the first end wall of the body and including a marking of information which is a subset of the information marked on the main label, wherein the radiopharmaceutical container is disposed in the receptacle in a manner such that viewing of the reference label is substantially unobstructed and such that viewing of at least a portion of the main label is substantially obstructed.

48. The storage container of claim 47, further comprising a syringe enclosed within the radiopharmaceutical container and a radiopharmaceutical disposed within the syringe.
